(19) United States
(12) Patent Application Publication
(10) Pub. No.: US 2021/0081680 A1
(43) Pub. Date: Mar. 18, 2021

(54) SYSTEM AND METHOD FOR IDENTIFYING ILLEGAL MOTOR VEHICLE ACTIVITY

(71) Applicant: Mike Gordon, Oceanside, NY (US)

(72) Inventor: Mike Gordon, Oceanside, NY (US)

(21) Appl. No.: 17/024,384

(22) Filed: Sep. 17, 2020

Related U.S. Application Data
(60) Provisional application No. 62/902,186, filed on Sep. 18, 2019.

(51) Int. Cl. G06K 9/00; H04N 5/232; G06Q 50/26

(52) U.S. Cl. CPC G06K 9/00791; H04N 5/23238; G06K 2209/15; G06Q 50/26; G06K 9/00711

(57) ABSTRACT

A system for identifying illegal motor vehicle activity includes a camera configured to capture a plurality of image of a vehicle of interest within a predetermined area in proximity to the camera. A license plate recognition (LPR) device reads characters displayed on a vehicle registration plate of the vehicle of interest. The LPR identifies an owner of the vehicle of interest. A computer including a processor and a memory records at least one image of the plurality of images displaying an occurrence of an illegal act performed by the vehicle of interest and identify information of the owner of the vehicle of interest based on the characters displayed on the vehicle registration plate of the vehicle of interest.

### CROSS REFERENCE TO RELATED APPLICATION

The present application claims the benefit of and priority to U.S. Provisional Application No. 62/902,186, filed Sep. 18, 2019. The entire contents of which are incorporated by reference herein.

### FIELD OF THE DISCLOSURE

The present disclosure relates to a system and method of identifying illegal motor vehicle activity. One or more exemplary embodiments of the present disclosure provide a system and method of identifying illegal motor vehicle activity by a roving vehicle.

### BACKGROUND

Parking enforcement often involves the use of identifying vehicles in the act of committing illegal activity. For example, police vehicles patrolling an area and occupied by a police officer may be within visual range of a vehicle committing a traffic violation such as crossing a double yellow line or driving through a red light. In such instances, an observing police officer may pull over such a vehicle and issue a ticket or summons to the operator of the vehicle. However, under such a system a vast majority of illegal activity carried out by a vehicle may go unnoticed.

Automated systems such as red light camera detection systems employ cameras to record vehicles passing through a red light. Red light detection systems employ video recordings by video cameras to record vehicle activity and an image of a license plate. However, the characters (e.g., letters and numbers) displayed on a license plate must subsequently be manually recorded by a person viewing the recorded video tape of the vehicle passing through the red light. Thus, license plates that are not visible in the recorded video footage may not be useful for identifying an operator or owner of a vehicle driving through a red light.

### SUMMARY

According to an exemplary embodiment of the present disclosure, a system for identifying illegal motor vehicle activity includes a camera configured to capture a plurality of image of a vehicle of interest within a predetermined area in proximity to the camera. A license plate recognition (LPR) device reads characters displayed on a vehicle registration plate of the vehicle of interest. The LPR identifies an owner of the vehicle of interest. A computer including a processor and a memory records at least one image of the plurality of images displaying an occurrence of an illegal act performed by the vehicle of interest and identify information of the owner of the vehicle of interest based on the characters displayed on the vehicle registration plate of the vehicle of interest.

According to an exemplary embodiment of the present disclosure, an antenna may transmit data of the at least one image of the plurality of images and data of the owner of the vehicle of interest. The data of the at least one image of the plurality of images and the data of the owner of the vehicle of interest may be transmitted to a remote server.

According to an exemplary embodiment of the present disclosure, the camera and LPR may be carried in a roving detection vehicle.

According to an exemplary embodiment of the present disclosure, a plurality of cameras may be arranged about the roving detection vehicle. The plurality of cameras may capture overlapping video images 360 degrees around the roving detection vehicle. The cameras may be digital video cameras. The digital video cameras may continuously record video data for a predetermined period of time.

According to an exemplary embodiment of the present disclosure, an antenna may transmit data of the at least one image of the plurality of images and data of the owner of the vehicle of interest to a remote server. The remote server may be a cloud based server.

According to an exemplary embodiment of the present disclosure, the system and/or the computer may include an antenna, such as a wireless antenna, configured to wirelessly transmit or receive data via a cell tower network, a WiFi signal or a Bluetooth signal.

According to an exemplary embodiment of the present disclosure, a method of identifying illegal motor vehicle activity includes capturing, by a camera, a plurality of images of a vehicle of interest within a predetermined area. The method includes reading, by a license plate recognition (LPR) device, characters displayed on a vehicle registration plate of the vehicle of interest and identifying an owner of the vehicle of interest. The method includes recording at least one image of the plurality of images displaying an occurrence of an illegal act performed by the vehicle of interest. The method includes recording identifying information of the owner of the vehicle of interest based on the characters displayed on the vehicle registration plate of the vehicle of interest.

According to an exemplary embodiment of the present disclosure, at least one image of the plurality of images and the identifying information of the owner of the vehicle may each be stored in a data file. The method may include transmitting the data file to a third party having authority to issue a ticket or summons for the owner of the vehicle of interest. The method may include preparing a ticket or summons for the owner of the vehicle of interest.

According to an exemplary embodiment of the present disclosure, the capturing of the plurality of images of the vehicle of interest and the reading of the characters displayed on the vehicle registration plate of the vehicle of interest may be performed substantially simultaneously.

According to an exemplary embodiment of the present disclosure, a plurality of cameras may capture overlapping video images 360 degrees around the roving detection vehicle.

According to an exemplary embodiment of the present disclosure, the camera and LPR may be carried in a roving detection vehicle.

According to an exemplary embodiment of the present disclosure, digital video may be recorded by the camera continuously for a predetermined period of time. Digital video files may be continuously transmitted to a remote server. The digital video files may be transmitted by a cell tower network connection, a WiFi signal or a Bluetooth signal.

### BRIEF DESCRIPTION OF THE FIGURES

The above and other features of the present disclosure will become more apparent by describing in detail exemplary embodiments thereof, with reference to the accompanying drawings, in which:

FIG. 1 illustrates a system for identifying illegal motor vehicle activity according to an exemplary embodiment of the present disclosure.

### DETAILED DESCRIPTION

It will be understood that the terms “first,” “second,” “third,” etc. are used herein to distinguish one element from another, and the elements are not limited by these terms. Thus, a “first” element in an exemplary embodiment may be described as a “second” element in another exemplary embodiment.

“About” or “approximately” as used herein may be inclusive of the stated value and means within an acceptable range of variation for the particular value as determined by one of ordinary skill in the art, considering the measurement in question and the error associated with measurement of the particular quantity (e.g., the limitations of the measurement system). For example, “about” may mean within one or more standard variations, or within ±30%, 20%, 10%, 5% of the stated value.

Descriptions of technical features or aspects of an exemplary embodiment of the present disclosure should typically be considered as available and applicable to other similar features or aspects in another exemplary embodiment of the present disclosure. Accordingly, technical features described herein according to one exemplary embodiment of the present disclosure may be applicable to other exemplary embodiments of the present disclosure, and thus duplicative descriptions may be omitted herein.

Exemplary embodiments of the present disclosure will be described more fully below (e.g., with reference to the accompanying drawings). Like reference numerals may refer to like elements throughout the specification and drawings.

Automatic number-plate recognition (ANPR) or automated License Plate Recognition (LPR) is a technology that may employ optical character recognition (e.g., on digital images) to read vehicle registration plates to create vehicle location data. ANPR/LPR can be performed by existing closed-circuit television, road-rule enforcement cameras, or cameras specifically designed for ANPR/LPR. ANPR/LPR may be employed by police for law enforcement purposes, including to check if a vehicle is registered or licensed.

ANPR/LPR may be used to store the images or video captured by cameras as well as the text from the license plate. Systems commonly use infrared lighting allow the camera to take the picture at any time of day or night.

An exemplary system of license plate detection is described in U.S. Pat. No. 5,651,075, the disclosure of which is incorporated by reference herein in its entirety.

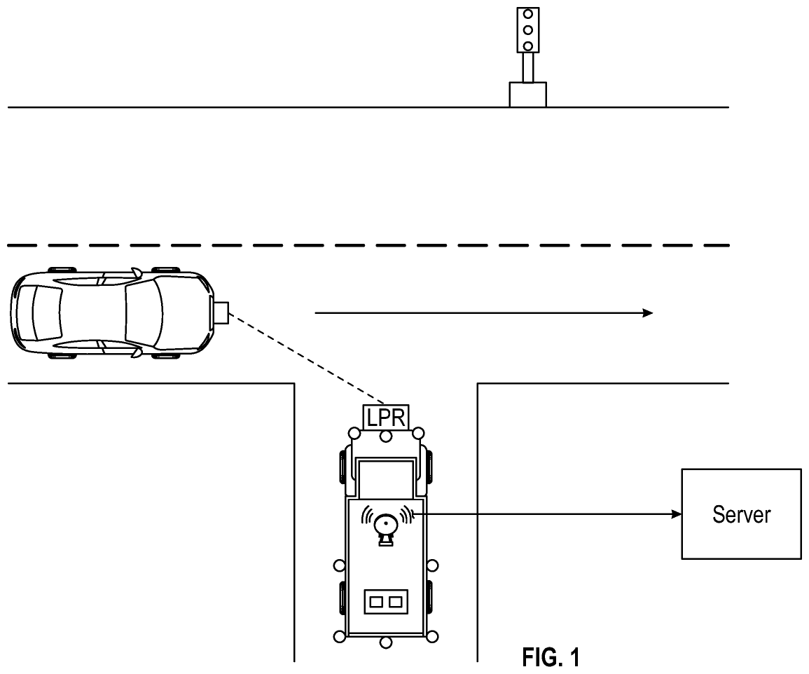

FIG. 1 illustrates a system for identifying illegal motor vehicle activity according to an exemplary embodiment of the present disclosure.

Referring to FIG. 1, according to an exemplary embodiment of the present disclosure, a system for identifying illegal motor vehicle activity includes a camera configured to capture a plurality of image of a vehicle of interest within a predetermined area in proximity to the camera. A license plate recognition (LPR) device reads characters displayed on a vehicle registration plate (i.e., a license plate) of the vehicle of interest. Front and/or rear license plates may be read. The vehicle of interest may be a stationary vehicle or a moving vehicle. The LPR identifies an owner of the vehicle of interest. A computer including a processor and a memory records at least one image of the plurality of images displaying an occurrence of an illegal act performed by the vehicle of interest and identifies information of the owner of the vehicle of interest based on the characters displayed on the vehicle registration plate of the vehicle of interest.

The LPR may be positioned on a roving carrier vehicle or may be located in a stationary position.

The illegal activity may include a parking violation or infraction or a moving violation or infraction.

The memory of the computer may store a database of registered license plates for identification of the owner of the vehicle of interest. Alternatively, a database of registered license plates may be stored on a remoter server and accessed by an antenna (e.g., a cell tower antenna, a WiFi antenna or a Bluetooth antenna) associated with the computer. The processor may execute computer instructions stored on the memory to perform desired functions associated with recording images of the vehicle of interest and/or the identity of the owner of interest. The memory and/or the remote server may store a database of traffic or moving violations, and such a database may be employed for identifying when a traffic or moving violation has been carried out by the vehicle of interest.

According to an exemplary embodiment of the present disclosure, an antenna (e.g., a wireless antenna) may transmit data of the at least one image of the plurality of images and data of the owner of the vehicle of interest. The data of the at least one image of the plurality of images and the data of the owner of the vehicle of interest may be transmitted to a remote server.

According to an exemplary embodiment of the present disclosure, the camera and LPR may be carried in a roving detection vehicle. A plurality of cameras may be arranged about the roving detection vehicle. The plurality of cameras may capture overlapping video images 360 degrees around the roving detection vehicle. The cameras may be digital video cameras. The digital video cameras may continuously record video data for a predetermined period of time.

According to an exemplary embodiment of the present disclosure, an antenna (e.g., a wireless antenna) may transmit data of the at least one image of the plurality of images and data of the owner of the vehicle of interest to a remote server. The remote server may be a cloud based server.

According to an exemplary embodiment of the present disclosure, the system and/or the computer may include an antenna, such as a wireless antenna, configured to wirelessly transmit or receive data via a cell tower network, a WiFi signal or a Bluetooth signal.

According to an exemplary embodiment of the present disclosure, a method of identifying illegal motor vehicle activity includes capturing, by a camera, a plurality of images of a vehicle of interest within a predetermined area. The method includes reading, by a license plate recognition (LPR) device, characters displayed on a vehicle registration plate (e.g. a license plate) of the vehicle of interest and identifying an owner of the vehicle of interest. The method includes recording at least one image of the plurality of images displaying an occurrence of an illegal act performed by the vehicle of interest. The method includes recording identifying information of the owner of the vehicle of interest based on the characters displayed on the vehicle registration plate of the vehicle of interest.

The identity of the owner of a vehicle carrying the license plate may be determined by accessing a database, as described herein, recording a list of all registered license plates within a predetermined area.

According to an exemplary embodiment of the present disclosure, data of a make, model and/or color of a vehicle may also be available (e.g., stored on a local or remote database) to determine if the license plate identified by the LPR matches the expected make, model and/or color. Thus, the systems and methods described herein may be employed to identify a presence of a stolen vehicle (e.g., in real-time). Similarly, a summons, ticket, or citation may be issued substantially in real-time through use of the system and methods described herein.

According to an exemplary embodiment of the present disclosure, at least one image of the plurality of images and the identifying information of the owner of the vehicle may each be stored in a data file. The method may include transmitting the data file to a third party having authority to issue a ticket or summons for the owner of the vehicle of interest. The method may include preparing a ticket or summons for the owner of the vehicle of interest.

According to an exemplary embodiment of the present disclosure, the capturing of the plurality of images of the vehicle of interest and the reading of the characters displayed on the vehicle registration plate of the vehicle of interest may be performed substantially simultaneously.

According to an exemplary embodiment of the present disclosure, a plurality of cameras may capture overlapping video images 360 degrees around the roving detection vehicle.

According to an exemplary embodiment of the present disclosure, digital video may be recorded by the camera continuously for a predetermined period of time. Digital video files may be continuously transmitted to a remote server. The digital video files may be transmitted by a cell tower network connection, a WiFi signal or a Bluetooth signal.

The disclosures of each of the references, patents and published patent applications disclosed herein are each incorporated by reference herein in their entireties.

In the event of a conflict between a definition herein and a definition incorporated by reference, the definition provided herein is intended.

Having described exemplary embodiments of the present disclosure, it is further noted that it is readily apparent to those of ordinary skill in the art that various modifications may be made without departing from the spirit and scope of the present disclosure.

What is claimed is:

1. A system for identifying illegal motor vehicle activity, comprising:
a camera configured to capture a plurality of image of a vehicle of interest within a predetermined area in proximity to the camera;
a license plate recognition (LPR) device configured to read characters displayed on a vehicle registration plate of the vehicle of interest and identify an owner of the vehicle of interest; and
a computer including a processor and a memory, the computer configured to record at least one image of the plurality of images displaying an occurrence of an illegal act performed by the vehicle of interest and identify information of the owner of the vehicle of interest based on the characters displayed on the vehicle registration plate of the vehicle of interest.

2. The system of claim 1, further including an antenna configured to transmit data of the at least one image of the plurality of images and data of the owner of the vehicle of interest.

3. The system of claim 1, wherein the camera and LPR are carried in a roving detection vehicle.

4. The system of claim 3, further including a plurality of cameras arranged about the roving detection vehicle.

5. The system of claim 4, wherein the plurality of cameras are configured to capture overlapping video images 360 degrees around the roving detection vehicle.

6. The system of claim 1, wherein the camera is a digital video camera.

7. The system of claim 6, wherein the digital video camera is configured to continuously record video data for a predetermined period of time.

8. The system of claim 1, further including an antenna configured to transmit data of the at least one image of the plurality of images and data of the owner of the vehicle of interest to a remote server.

9. The system of claim 1, wherein the remote server is a cloud based server.

10. The system of claim 1, wherein the computer includes an antenna configured to wirelessly transmit or receive data via a cell tower network, a WiFi signal or a Bluetooth signal.

11. A method of identifying illegal motor vehicle activity, comprising:
capturing, by a camera, a plurality of images of a vehicle of interest within a predetermined area;
reading, by a license plate recognition (LPR) device, characters displayed on a vehicle registration plate of the vehicle of interest and identifying an owner of the vehicle of interest;
recording at least one image of the plurality of images displaying an occurrence of an illegal act performed by the vehicle of interest, and recording identifying information of the owner of the vehicle of interest based on the characters displayed on the vehicle registration plate of the vehicle of interest.

12. The method of claim 11, wherein the at least one image of the plurality of images and the identifying information of the owner of the vehicle are each stored in a data file.

13. The method of claim 12, further including preparing a ticket or summons for the owner of the vehicle of interest.

14. The method of claim 12, further including transmitting the data file to a third party having authority to issue a ticket or summons for the owner of the vehicle of interest.

15. The method of claim 11, wherein the capturing of the plurality of images of the vehicle of interest and the reading of the characters displayed on the vehicle registration plate of the vehicle of interest are performed substantially simultaneously.

16. The method of claim 11, wherein a plurality of cameras capture overlapping video images 360 degrees around the roving detection vehicle.

17. The method of claim 11, wherein the camera and LPR are carried in a roving detection vehicle.

18. The method of claim 11, wherein digital video is recorded by the camera continuously for a predetermined period of time.

19. The method of claim 18, wherein digital video files are continuously transmitted to a remote server.

20. The method of claim 19, wherein the digital video files are transmitted by a cell tower network connection, a WiFi signal or a Bluetooth signal.
